(19) United States
(12) Patent Application Publication
(10) Pub. No.: US 2024/0272428 A1
(43) Pub. Date: Aug. 15, 2024

(54) HEAD-UP DISPLAY (HUD) WITH A LIGHT BEAM SCANNER HAVING A FIELD CURVATURE MATCHED WITH A HUD PROJECTION

(71) Applicant: Infineon Technologies AG, Neubiberg (DE)

(72) Inventors: Boris KIRILLOV, Gratwein-Straßengel (AT); Maksym Yuriiovych SLADKOV, Graz (AT)

(21) Appl. No.: 18/166,892

(22) Filed: Feb. 9, 2023

(51) Int. Cl. G02B 27/01; B60K 35/00; G02B 5/10; G02B 26/08; G02B 26/10

(52) U.S. Cl. CPC G02B 27/0101; B60K 35/00; G02B 5/10; G02B 26/0833; G02B 26/101; B60K 35/23; B60K 35/81; B60K 2360/23; B60K 2360/66

(57) ABSTRACT

A head-up display (HUD) system includes a light transmitter configured to generate a plurality of pixel light beams corresponding to an image and transmit the plurality of pixel light beams on an optical path; a two-dimensional (2D) scanner arranged on the optical path, wherein the 2D scanner is configured to receive the plurality of pixel light beams from the light transmitter and steer the plurality of pixel light beams along the optical path according to a 2D scanning pattern; and a diffuser screen arranged on the optical path downstream from the 2D scanner, wherein the diffuser screen comprises a curved body with a surface curvature. The diffuser screen is configured to expand a beam width of each pixel light beam to generate a plurality of divergent pixel light beams. The 2D scanner has a projection field curvature that is substantially matched with the surface curvature of the diffuser screen.

### BACKGROUND

Augmented reality (AR) is a technology that augments physical environments on a mobile device screen by overlaying them with digital content. It adds digital elements to a live view. For example, a captured piece of an environment is augmented with digital information that is superimposed thereon. Thus, digital content is overlaid onto the captured piece of the environment to visually provide additional information to a user. The digital content may be displayed on a transparent substrate or display, such as smart eye-glasses, smart contact lenses, head-up displays (HUDs), and head-mounted displays (HMDs), or projected directly onto a user's retina, as is the case for virtual retinal displays.

Virtual reality (VR) is a technology that entirely replaces the real-world environment of a user with a computer-generated virtual environment. Thus, a user is presented with a completely digital environment. In particular, computer-generated stereo visuals entirely surround the user. In a VR simulated environment, a VR headset that provides 360-degree vision may be used.

A mixed reality (MR) experience combines elements of both AR and VR such that real-world and digital objects interact. Here, a real-world environment is blended with a virtual one.

These technologies, as well as others that enhance a user's senses, may be referred to as extended reality (XR) technologies.

### SUMMARY

In some implementations, a head-up display (HUD) system includes a HUD reflector comprising a first curved body with a first surface curvature that is configured to produce a reflector field curvature in object space; a light transmitter configured to generate a plurality of pixel light beams corresponding to an image and transmit the plurality of pixel light beams on an optical path toward the HUD reflector; a two-dimensional (2D) scanner arranged on the optical path, wherein the 2D scanner is configured to receive the plurality of pixel light beams from the light transmitter and steer the plurality of pixel light beams along the optical path according to a 2D scanning pattern; and a diffuser screen arranged on the optical path between the 2D scanner and the HUD reflector, wherein the diffuser screen comprises a second curved body with a second surface curvature that is substantially matched with the reflector field curvature, wherein the diffuser screen is configured to receive the plurality of pixel light beams from the 2D scanner and expand a beam width of each pixel light beam of the plurality of pixel light beams to generate a plurality of divergent pixel light beams, and wherein the HUD reflector is configured to receive the plurality of divergent pixel light beams from the diffuser screen and reflect the plurality of divergent pixel light beams toward a field of view.

In some implementations, a HUD system includes a light transmitter configured to generate a plurality of pixel light beams corresponding to an image and transmit the plurality of pixel light beams on an optical path; a 2D scanner arranged on the optical path, wherein the 2D scanner is configured to receive the plurality of pixel light beams from the light transmitter and steer the plurality of pixel light beams along the optical path according to a 2D scanning pattern; and a diffuser screen arranged on the optical path downstream from the 2D scanner, wherein the diffuser screen comprises a curved body with a surface curvature, and wherein the diffuser screen is configured to receive the plurality of pixel light beams from the 2D scanner and expand a beam width of each pixel light beam of the plurality of pixel light beams to generate a plurality of divergent pixel light beams, and wherein the 2D scanner has a projection field curvature that is substantially matched with the surface curvature of the diffuser screen.

In some implementations, a HUD system includes a light transmitter configured to generate a plurality of pixel light beams corresponding to an image and transmit the plurality of pixel light beams on an optical path; a 2D scanner arranged on the optical path, wherein the 2D scanner is configured to receive the plurality of pixel light beams from the light transmitter and steer the plurality of pixel light beams along the optical path according to a 2D scanning pattern; a diffuser screen arranged on the optical path downstream from the 2D scanner, wherein the diffuser screen comprises a curved body having a surface curvature, and wherein the diffuser screen is configured to receive the plurality of pixel light beams from the 2D scanner and expand a beam width of each pixel light beam of the plurality of pixel light beams to generate a plurality of divergent pixel light beams; and a pre-scan lens arranged on the optical path between the light transmitter and the 2D scanner, wherein the pre-scan lens is configured to receive the plurality of pixel light beams from the light transmitter and focus the plurality of pixel light beams onto the diffuser screen, wherein a focal length of the pre-scan lens is equal to a sum of a first distance between the pre-scan lens and the 2D scanner, along the optical path, and a second distance between the 2D scanner and the diffuser screen, along the optical path, and wherein the second distance is substantially equal to a radius of the surface curvature.

### BRIEF DESCRIPTION OF THE DRAWINGS

Implementations are described herein making reference to the appended drawings.

FIG. 1A is a schematic block diagram of a 2D scanning system according to one or more implementations.

FIG. 1B is a schematic block diagram of a 2D scanning system according to one or more implementations.

FIG. 2 illustrates an example HUD system according to one or more implementations.

FIG. 3 illustrates an example HUD system according to one or more implementations.

FIG. 4 illustrates an example image generation unit according to one or more implementations.

FIG. 5A illustrates an example HUD system according to one or more implementations.

FIG. 5B illustrates an example HUD system according to one or more implementations.

### DETAILED DESCRIPTION

In the following, details are set forth to provide a more thorough explanation of example implementations. However, it will be apparent to those skilled in the art that these implementations may be practiced without these specific details. In other instances, well-known structures and devices are shown in block diagram form or in a schematic view rather than in detail in order to avoid obscuring the implementations. In addition, features of the different implementations described hereinafter may be combined with each other, unless specifically noted otherwise.

Further, equivalent or like elements or elements with equivalent or like functionality are denoted in the following description with equivalent or like reference numerals. As the same or functionally equivalent elements are given the same reference numbers in the figures, a repeated description for elements provided with the same reference numbers may be omitted. Hence, descriptions provided for elements having the same or like reference numbers are mutually exchangeable.

In this regard, directional terminology, such as “top,” “bottom,” “below,” “above,” “front,” “behind,” “back,” “leading,” “trailing,” etc., may be used with reference to an orientation of the figures being described. Because parts of the implementations, described herein, can be positioned in a number of different orientations, the directional terminology is used for purposes of illustration and is in no way limiting. It is to be understood that other implementations may be utilized and structural or logical changes may be made without departing from the scope defined by the claims. The following detailed description, therefore, is not to be taken in a limiting sense.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

As used herein, the terms “substantially” and “approximately” mean “within reasonable tolerances of manufacturing and measurement.” For example, the terms “substantially” and “approximately” may be used herein to account for small manufacturing tolerances or other factors (e.g., within 5%) that are deemed acceptable in the industry without departing from the aspects of the implementations described herein. For example, a resistor with an approximate resistance value may practically have a resistance within 5% of the approximate resistance value. As another example, an approximate signal value may practically have a signal value within 5% of the approximate signal value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

A head-up display (HUD), sometimes referred to as a heads-up display, is any transparent display that presents data without requiring users to look away from their usual viewpoints. For example, a HUD may be used in a vehicle to display images on a windshield.

Building a compact automotive HUD can be a challenging task. For example, a HUD system may be integrated under a dashboard of a vehicle and, therefore, can be limited to a small area within the dashboard. A size of the HUD system is often in a trade-off with performance and cost. Achieving compact size and high performance can increase optical aberrations to be corrected. One type of optical aberration is field of curvature, sometimes referred to as Petzval field curvature. The field of curvature is produced when one projects a thin-film-transistor liquid-crystal display (TFT LCD) panel into a driver's line of sight using a large HUD reflector that may be present in a HUD optical architecture. Field of curvature in such architecture can be corrected with additional optical elements, such as a field flattener lens arranged on top of the TFT LCD panel. However, using a field flattener lens arranged on top of the TFT LCD panel increases complexity and system cost.

Some implementations disclosed herein are directed to a HUD system that has a light beam scanning (LBS)-based architecture with an intermediate diffuser screen (e.g., a diffuser) that has a curved surface with a surface curvature that matches a field of curvature (e.g., a Petzval field curvature) of a HUD reflector. In some cases, the surface curvature of the intermediate diffuser screen may substantially match a surface curvature of the HUD reflector.

In some implementations, the HUD system includes a 2D scanner that has a projection field curvature that is substantially matched with the field of curvature of the HUD reflector. The projection field curvature is a curved projection plane, formed by a scanning movement of the 2D scanner, at which light beams projected by the 2D scanner are in focus.

In some implementations, the projection field curvature of the 2D scanner may be matched or substantially matched with the surface curvature of the intermediate diffuser screen.

In some implementations, the projection field curvature of the 2D scanner may overlap with the reflector field curvature of the HUD reflector.

In some implementations, the intermediate diffuser screen may overlap with the projection field curvature of the 2D scanner.

As a result, an image that is projected by the HUD system may remain in focus throughout an entire scanning operation of the 2D scanner. In other words, the image may be enhanced by the HUD system.

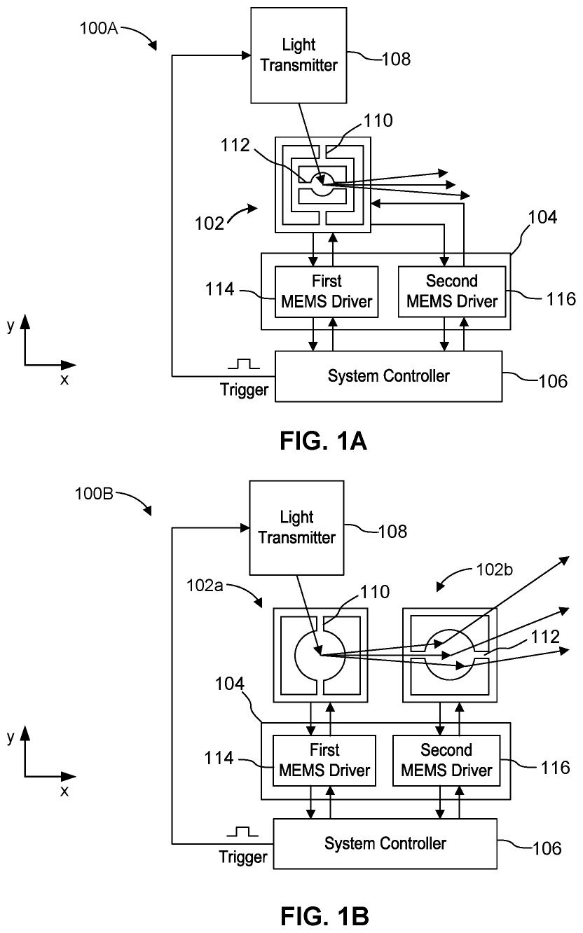

FIG. 1A is a schematic block diagram of a 2D scanning system 100A according to one or more implementations. In particular, the 2D scanning system 100A includes a microelectromechanical system (MEMS) mirror 102 implemented as a single scanning structure that is configured to steer or otherwise deflect light beams according to a 2D scanning pattern. The 2D scanning system 100A further includes a MEMS driver system 104, a system controller 106, and a light transmitter 108.

In the example shown in FIG. 1A, the MEMS mirror 102 is a mechanical moving mirror (e.g., a MEMS micro-mirror) integrated on a semiconductor chip (not shown). The MEMS mirror 102 is configured to rotate or oscillate via rotation about two scanning axes that are typically orthogonal to each other. For example, the two scanning axes may include a first scanning axis 110 that enables the MEMS mirror 102 to steer light in a first scanning direction (e.g., an x-direction) and a second scanning axis 112 that enables the MEMS mirror 102 to steer light in a second scanning direction (e.g., a y-direction). As a result, the MEMS mirror 102 can direct light beams in two dimensions according to the 2D scanning pattern and may be referred to as a 2D MEMS mirror.

A scan can be performed to illuminate an area referred to as a field of view. The scan, such as an oscillating horizontal scan (e.g., from left to right and right to left of a field of view), an oscillating vertical scan (e.g., from bottom to top and top to bottom of a field of view), or a combination thereof (e.g., a Lissajous scan or a raster scan) can illuminate the field of view in a continuous scan fashion. In some implementations, the 2D scanning system 100A may be configured to transmit successive light beams, for example, as successive light pulses, in different scanning directions to scan the field of view. In other words, the field of view can be illuminated by a scanning operation. In general, an entire field of view represents a scanning area defined by a full range of motion of the MEMS mirror 102 at which the MEMS mirror 102 is driven. Thus, the entire field of view is delineated by a left edge, a right edge, a bottom edge, and a top edge. The entire field of view can also be referred to as a field of illumination or as a projection area in a projection plane onto which an image is projected.

The MEMS mirror 102 can direct a transmitted light beam at a desired 2D coordinate (e.g., an x-y coordinate) in the field of view. In image projection systems, the desired 2D coordinate may correspond to an image pixel of a projected image, with different 2D coordinates corresponding to different image pixels of the projected image. Accordingly, multiple light beams transmitted at different transmission times can be steered by the MEMS mirror 102 at the different 2D coordinates of the field of view in accordance with the 2D scanning pattern. The MEMS mirror 102 can be used to scan the field of view in both scanning directions by changing an angle of deflection of the MEMS mirror 102 on each of the first scanning axis 110 and the second scanning axis 112.

A rotation of the MEMS mirror 102 on the first scanning axis 110 may be performed between two predetermined extremum deflection angles (e.g., +/−5 degrees, +/−15 degrees, etc.). Likewise, a rotation of the MEMS mirror 102 on the second scanning axis 112 may be performed between two predetermined extremum deflection angles (e.g., +/−5 degrees, +/−15 degrees, etc.). In some implementations, depending on the 2D scanning pattern, the two predetermined extremum deflection angles used for the first scanning axis 110 may be the same as the two predetermined extremum deflection angles used for the second scanning axis 112. In some implementations, depending on the 2D scanning pattern, the two predetermined extremum deflection angles used for the first scanning axis 110 may be different from the two predetermined extremum deflection angles used for the second scanning axis 112.

In some implementations, the MEMS mirror 102 can be a resonator (e.g., a resonant MEMS mirror) configured to oscillate side-to-side about the first scanning axis 110 at a first frequency (e.g., a first resonance frequency) and configured to oscillate side-to-side about the second scanning axis 112 at a second frequency (e.g., a second resonance frequency). Thus, the MEMS mirror 102 can be continuously driven about the first scanning axis 110 and the second scanning axis 112 to perform a continuous scanning operation. As a result, light beams reflected by the MEMS mirror 102 are scanned into the field of view in accordance with the 2D scanning pattern.

Different frequencies or a same frequency may be used for the first scanning axis 110 and the second scanning axis 112 for defining the 2D scanning pattern. For example, a raster scanning pattern or a Lissajous scanning pattern may be achieved by using different frequencies for the first frequency and the second frequency. Raster scanning and Lissajous scanning are two types of scanning that can be implemented in display applications, light scanning applications, and light steering applications, to name a few. As an example, Lissajous scanning is typically performed using two resonant scanning axes which are driven at different constant scanning frequencies with a defined fixed frequency ratio therebetween that forms a specific Lissajous pattern and frame rate. In order to properly carry out the Lissajous scanning and the raster scanning, synchronization of the two scanning axes is performed by the system controller 106 in conjunction with transmission timings of the light transmitter 108.

For each respective scanning axis, including the first scanning axis 110 and the second scanning axis 112, the MEMS mirror 102 includes an actuator structure used to drive the MEMS mirror 102 about the respective scanning axis. Each actuator structure may include interdigitated finger electrodes made of interdigitated mirror combs and frame combs to which a drive voltage (e.g., an actuation signal or driving signal) is applied by the MEMS driver system 104. Applying a difference in electrical potential between interleaved mirror combs and frame combs creates a driving force between the mirror combs and the frame combs, which creates a torque on a mirror body of the MEMS mirror 102 about the intended scanning axis. The drive voltage can be toggled between two voltages, resulting in an oscillating driving force. The oscillating driving force causes the MEMS mirror 102 to oscillate back and forth on the respective scanning axis between two extrema. Depending on the configuration, this actuation can be regulated or adjusted by adjusting the drive voltage off time, a voltage level of the drive voltage, or a duty cycle.

In other examples, the MEMS mirror 102 may use other actuation methods to drive the MEMS mirror 102 about the respective scanning axes. For example, these other actuation methods may include electromagnetic actuation and/or piezoelectric actuators. In electromagnetic actuation, the MEMS mirror 102 may be immersed in a magnetic field, and an alternating electric current through conductive paths may create the oscillating torque around the scanning axis. Piezoelectric actuators may be integrated in leaf springs of the MEMS mirror 102, or the leaf springs may be made of piezoelectric material to produce alternating beam bending forces in response to an electrical signal to generate the oscillation torque.

The MEMS driver system 104 is configured to generate driving signals (e.g., actuation signals) to drive the MEMS mirror 102 about the first scanning axis 110 and the second scanning axis 112. In particular, the MEMS driver system 104 is configured to apply the driving signals to the actuator structure of the MEMS mirror 102. In some implementations, the MEMS driver system 104 includes a first MEMS driver 114 configured to drive the MEMS mirror 102 about the first scanning axis 110 and a second MEMS driver 116 configured to drive the MEMS mirror 102 about the second scanning axis 112. In implementations in which the MEMS mirror 102 is used as an oscillator, the first MEMS driver 114 configured to drive an oscillation of the MEMS mirror 102 about the first scanning axis 110 at the first frequency, and the second MEMS driver 116 is configured to drive an oscillation of the MEMS mirror 102 about the second scanning axis 112 at the second frequency.

The first MEMS driver 114 may be configured to sense a first rotational position of the MEMS mirror 102 about the first scanning axis 110 and provide first position information indicative of the first rotational position (e.g., tilt angle or degree of rotation about the first scanning axis 110) to the system controller 106. Similarly, the second MEMS driver 116 may be configured to sense a second rotational position of the MEMS mirror 102 about the second scanning axis 112 and provide second position information indicative of the second rotational position (e.g., tilt angle or degree of rotation about the second scanning axis 112) to the system controller 106.

The system controller 106 may use the first position information and the second position information to trigger light beams at the light transmitter 108. For example, the system controller 106 may use the first position information and the second position information to set a transmission time of light transmitter 108 in order to target a particular 2D coordinate of the 2D scanning pattern. Thus, a higher accuracy in position sensing of the MEMS mirror 102 by the first MEMS driver 114 and the second MEMS driver 116 may result in the system controller 106 providing more accurate and precise control of other components of the 2D scanning system 100A.

As noted above, the first MEMS driver 114 and the second MEMS driver 116 may apply a drive voltage to a corresponding actuator structure of the MEMS mirror 102 as the driving signal to drive a rotation (e.g., an oscillation) of the MEMS mirror 102 about a respective scanning axis (e.g., the first scanning axis 110 or the second scanning axis 112). The drive voltage can be switched or toggled between a high-voltage (HV) level and a low-voltage (LV) level resulting in an oscillating driving force. In some implementations, the LV level may be zero (e.g., the drive voltage is off), but is not limited thereto and could be a non-zero value. When the drive voltage is toggled between an HV level and an LV level and the LV level is set to zero, it can be said that the drive voltage is toggled on and off (HV on/off). The oscillating driving force causes the MEMS mirror 102 to oscillate back and forth on the first scanning axis 110 or the second scanning axis 112 between two extrema. The drive voltage may be a constant drive voltage, meaning that the drive voltage is the same voltage when actuated (e.g., toggled on) or one or both of the HV level or the LV level of the drive voltage may be adjustable. However, it will be understood that the drive voltage is being toggled between the HV level and the LV level in order to produce the mirror oscillation. Depending on a configuration, this actuation can be regulated or adjusted by the system controller 106 by adjusting the drive voltage off time, a voltage level of the drive voltage, or a duty cycle. As noted above, frequency and phase of the drive voltage can also be regulated and adjusted.

In some implementations, the system controller 106 is configured to set a driving frequency of the MEMS mirror 102 for each scanning axis and is capable of synchronizing the oscillations about the first scanning axis 110 and the second scanning axis 112. In particular, the system controller 106 may be configured to control an actuation of the MEMS mirror 102 about each scanning axis by controlling the driving signals. The system controller 106 may control the frequency, the phase, the duty cycle, the HV level, and/or the LV level of the driving signals to control the actuations about the first scanning axis 110 and the second scanning axis 112. The actuation of the MEMS mirror 102 about a particular scanning axis controls its range of motion and scanning rate about that particular scanning axis.

For example, to make a Lissajous scanning pattern reproduce itself periodically with a frame rate frequency, the first frequency at which the MEMS mirror 102 is driven about the first scanning axis 110 and the second frequency at which the MEMS mirror 102 is driven about the second scanning axis 112 are different. A difference between the first frequency and the second frequency is set by a fixed frequency ratio that is used by the 2D scanning system 100A to form a repeatable Lissajous pattern (frame) with a frame rate. A new frame begins each time the Lissajous scanning pattern restarts, which may occur when a phase difference between a mirror phase about the first scanning axis 110 and a mirror phase about the second scanning axis 112 is zero. The system controller 106 may set the fixed frequency ratio and synchronize the oscillations about the first scanning axis 110 and the second scanning axis 112 to ensure this fixed frequency ratio is maintained based on the first position information and the second position information received from the first MEMS driver 114 and the second MEMS driver 116, respectively.

The light transmitter 108 may be a red-green-blue (RGB) light transmitter having red (R), green (G), and blude (B) light sources configured to generate RGB light beams. For example, the light transmitter 108 may include a red laser diode or light emitting diode for generating a red light beam, a green laser diode or light emitting diode for generating a green light beam, a blue laser diode or light emitting diode for generating a blue light beam, and first optical elements that combine the three colored light beams into an RGB light beam for output from the light transmitter 108. Accordingly, the light transmitter 108 is configured to transmit each RGB light beam on a transmission path towards the MEMS mirror 102. Each RGB light beam may be generated as a light pulse, and the light transmitter 108 may sequentially transmit multiple RGB light beams as the MEMS mirror 102 changes its transmission direction in order to target different 2D coordinates. A transmission sequence of the multiple RGB light beams and a timing thereof may be implemented by the light transmitter 108 according to a trigger signal received from the system controller 106.

It is to be noted that a particular RGB light beam may be made of a single color of light, a combination of two colors of light, or a combination of all three colors or light. For example, the system controller 106 may control which R, G, B light sources of the light transmitter 108 is triggered for a light transmission, including some or all of the R, G, B light sources. While some of the R, G, B light sources may remain inactive during a light transmission, an output light beam may still be referred to as an RGB light beam (e.g., despite not including all three colors of light). Alternatively, an “RGB light beam” may be referred to as a “pixel light beam” that includes one or more colors of light depending on the desired pixel color to be projected into the field of view. For example, a particular RGB light beam may correspond to a pixel of an image projected into the field of view or an image projected onto a display and different RGB light beams may be transmitted for different pixels of the image or for different image frames. Thus, the terms “RGB light beam” and “pixel light beam” can be used interchangeably.

The system controller 106 is configured to control components of the 2D scanning system 100A. In certain applications, the system controller 106 may also be configured to receive programming information with respect to the 2D scanning pattern and control a timing of the plurality of light beams generated by the light transmitter 108 based on the programming information. Thus, the system controller 106 may include both processing and control circuitry that is configured to generate control signals for controlling the light transmitter 108, the first MEMS driver 114, and the second MEMS driver 116.

The system controller 106 is configured to set the driving frequencies of the MEMS mirror 102 for the first scanning axis 110 and the second scanning axis 112 and is capable of synchronizing the oscillations about the first scanning axis 110 and the second scanning axis 112 to generate the 2D scanning pattern. In some implementations, in which the plurality of light beams is used, the system controller 106 may be configured to generate the trigger signal used for triggering the light transmitter 108 to generate the plurality of light beams. Using the trigger signal, the system controller 106 can control the transmission times of the plurality of light beams (e.g., RGB light beams or pixel light beams) of the light transmitter 108 to achieve a desired illumination pattern within the field of view. The desired illumination pattern is produced by a combination of the 2D scanning pattern produced by the MEMS mirror 102 and the transmission times triggered by the system controller 106. In some implementations in which the continuous light beam is used, the system controller 106 may be configured to control a frequency modulation of the continuous light beam via a control signal provided to the light transmitter 108.

As indicated above, FIG. 1A is provided merely as an example. Other examples are possible and may differ from what was described with regard to FIG. 1A. In practice, the 2D scanning system 100A may include additional components, fewer components, different components, or differently arranged components than those shown in FIG. 1A without deviating from the disclosure provided above. In addition, in some implementations, the 2D scanning system 100A may include one or more additional 2D MEMS mirrors or one or more additional light transmitters used to scan one or more additional field of views. Additionally, two or more components shown in FIG. 1A may be implemented within a single component, or a single component shown in FIG. 1A may be implemented as multiple, distributed components. Additionally, or alternatively, a set of components (e.g., one or more components) of the 2D scanning system 100A may perform one or more functions described as being performed by another set of components of the 2D scanning system 100A.

FIG. 1B is a schematic block diagram of a 2D scanning system 100B according to one or more implementations. In particular, the 2D scanning system 100B includes two MEMS mirrors, a first MEMS mirror 102a and a second MEMS mirror 102b, that are optically coupled in series to steer or otherwise deflect light beams according to a 2D scanning pattern. The first MEMS mirror 102a and the second MEMS mirror 102b are similar to the MEMS mirror 102 described in FIG. 1A, with the exception that the first MEMS mirror 102a and the second MEMS mirror 102b are configured to rotate about a single scanning axis instead of two scanning axes. The first MEMS mirror 102a is configured to rotate about the first scanning axis 110 to steer light in the x-direction and the second MEMS mirror 102b is configured to rotate about the second scanning axis 112 to steer light in the y-direction. Similar to the MEMS mirror 102 described in FIG. 1A, the first MEMS mirror 102a and the second MEMS mirror 102b may be resonant MEMS mirrors configured to oscillate about the first scanning axis 110 and the second scanning axis 112, respectively.

Because each of the first MEMS mirror 102a and the second MEMS mirror 102b is configured to rotate about a single scanning axis, each of the first MEMS mirror 102a and the second MEMS mirror 102b is responsible for scanning light in one dimension. As a result, the first MEMS mirror 102a and the second MEMS mirror 102b may be referred to as one-dimensional (1D) MEMS mirrors. In the example shown in FIG. 1B, the first MEMS mirror 102a and the second MEMS mirror 102b are used together to steer light beams in two dimensions. The first MEMS mirror 102a and the second MEMS mirror 102b are arranged sequentially along a transmission path of the light beams such that one of the MEMS mirrors (e.g., the first MEMS mirror 102a) first receives a light beam and steers the light beam in a first dimension and the second one of the MEMS mirrors (e.g., the second MEMS mirror 102b) receives the light beam from the first MEMS mirror 102a and steers the light beam in a second dimension. As a result, the first MEMS mirror 102a and the second MEMS mirror 102b operate together to steer the light beam generated by the light transmitter 108 in two dimensions. In this way, the first MEMS mirror 102a and the second MEMS mirror 102b can direct the light beam at a desired 2D coordinate (e.g., an x-y coordinate) in the field of view. Multiple light beams can be steered by the first MEMS mirror 102a and the second MEMS mirror 102b at different 2D coordinates of a 2D scanning pattern.

The MEMS driver system 104, the system controller 106, and the light transmitter 108 are configured to operate as similarly described above in reference to FIG. 1A. The first MEMS driver 114 is electrically coupled to the first MEMS mirror 102a to drive the first MEMS mirror 102a about the first scanning axis 110 and to send a position of the first MEMS mirror 102a about the first scanning axis 110 to provide first position information to the system controller 106. Similarly, the second MEMS driver 116 is electrically coupled to the second MEMS mirror 102b to drive the second MEMS mirror 102b about the second scanning axis 112 and to send a position of the second MEMS mirror 102b about the second scanning axis 112 to provide second position information to the system controller 106.

As indicated above, FIG. 1B is provided merely as an example. Other examples are possible and may differ from what was described with regard to FIG. 1B. In practice, the 2D scanning system 100B may include additional components, fewer components, different components, or differently arranged components than those shown in FIG. 1B without deviating from the disclosure provided above. In addition, in some implementations, the 2D scanning system 100B may include one or more additional 1D MEMS mirrors or one or more additional light transmitters used to scan one or more additional field of views. Additionally, two or more components shown in FIG. 1B may be implemented within a single component, or a single component shown in FIG. 1B may be implemented as multiple, distributed components. Additionally, or alternatively, a set of components (e.g., one or more components) of the 2D scanning system 100B may perform one or more functions described as being performed by another set of components of the 2D scanning system 100B.

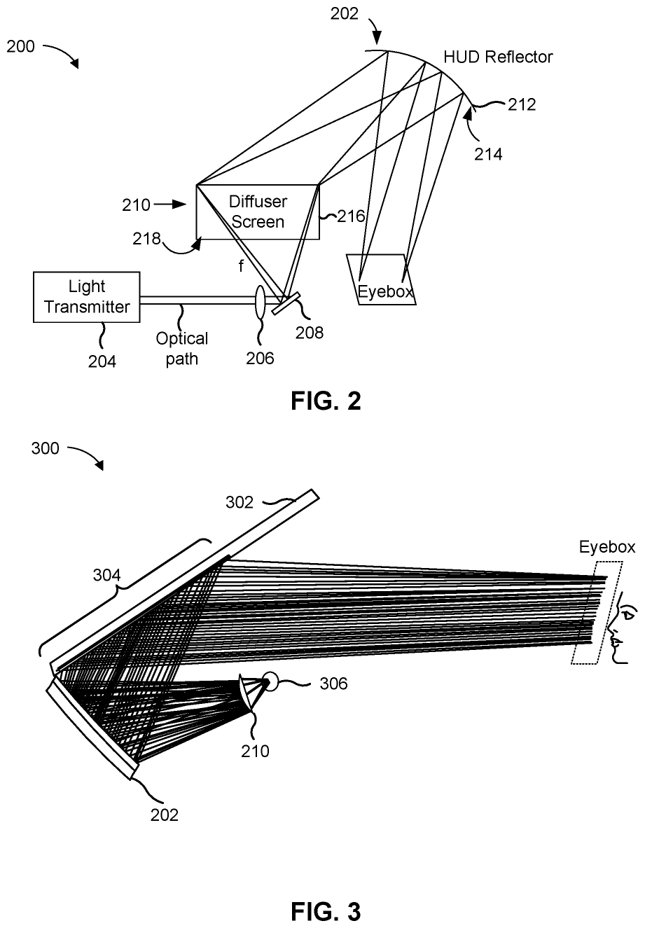

FIG. 2 illustrates an example HUD system 200 according to one or more implementations. The HUD system 200 may include a HUD reflector 202 (e.g., a HUD mirror) and a light transmitter 204 that may be configured to generate a plurality of pixel light beams corresponding to an image and transmit the plurality of pixel light beams on an optical path toward the HUD reflector. The HUD system 200 may further include a pre-scan lens 206, a 2D scanner 208, and a diffuser screen 210 that are arranged sequentially along the optical path between the light transmitter 204 and the HUD reflector 202.

The HUD system 200 may be configured to project the image into a region referred to as an “eyebox.” The eyebox may be an area in which the image projected by the HUD system 200 can be perceived by a user. In other words, an eye-level of a user should be located within the eyebox to properly view the image. The eyebox should be able to accommodate users of different heights and different movements of the user, while enabling a user or different users to view the image. A smaller eyebox may be limiting in the sense that users of certain heights (e.g., users that are too short or too tall) may not reside, at eye-level, within the eyebox. In addition, a smaller eyebox may be limiting in the sense that a user's range of motion may be confined to smaller movements in order to maintain an ability to view the image. In contrast, a larger eyebox may accommodate a larger range of user heights and motions. Therefore, it may be beneficial to increase a size of the eyebox to enable the image to be viewed by differently-sized users and to enable a greater range of motion while using the HUD system 200.

The light transmitter 204 may be similar to the light transmitter 108 described in connection with FIGS. 1A and 1B. In some implementations, the light transmitter 204 may be part of an image generation unit that includes the 2D scanner 208. For example, the light transmitter 204 and the 2D scanner 208 may be used together to generate the image. The light transmitter 204 may be configured to sequentially generate a plurality of pixel light beams corresponding to an image and, thereby, sequentially transmit the plurality of pixel light beams on the optical path towards the 2D scanner 208.

The 2D scanner 208 may be a MEMS mirror that is included in a 2D scanning system similar to the 2D scanning system 100A described in connection with FIG. 1A or similar to the 2D scanning system 100B described in connection with FIG. 1B. Thus, the 2D scanner 208 may be configured to receive the plurality of pixel light beams from the light transmitter 204 and steer the plurality of pixel light beams along the optical path according to a 2D scanning pattern. For example, as the 2D scanner 208 changes its angle of deflection during a scanning operation, the 2D scanner 208 may scan the plurality of pixel light beams onto the diffuser screen 210 according to the 2D scanning pattern. A scanning motion of the 2D scanner 208 may produce a projection field curvature (e.g., a field curvature of LBS projection). The projection field curvature is representative of a virtual (e.g., imaginary) surface where projected light beams would be in-focus. Due to the scanning motion of the 2D scanner about a scanning axis (or two scanning axes), the projection field curvature is a curved projection plane that has a virtual surface curvature.

The pre-scan lens 206 may be used to focus the plurality of pixel light beams onto the diffuser screen 210 such that the image in projected in focus onto the diffuser screen 210. For example, the pre-scan lens 206 may be arranged on the optical path between the light transmitter 204 and the 2D scanner 208, and the pre-scan lens may be configured to receive the plurality of pixel light beams from the light transmitter 204 and focus the plurality of pixel light beams onto the diffuser screen 210. The pre-scan lens 206 may have a focal length f that is equal to a sum of a first distance between the pre-scan lens 206 and the 2D scanner 208, along the optical path, and a second distance between the 2D scanner 208 and the diffuser screen 210, along the optical path. In some implementations, the focal length of the pre-scan lens 206 is equal to or substantially equal to half of a radius of a surface curvature of the HUD reflector 202. Additionally, or alternatively, the second distance between the 2D scanner 208 and the diffuser screen 210 may be equal to or substantially equal to a radius of a surface curvature of the diffuser screen 210.

The diffuser screen 210 may be arranged on the optical path between the 2D scanner 208 and the HUD reflector 202. The diffuser screen 210 may be configured to receive the plurality of pixel light beams from the 2D scanner 208 and expand a beam width of each pixel light beam of the plurality of pixel light beams to generate a plurality of divergent pixel light beams. In other words, the diffuser screen 210 is a diffuser optical component that may be configured to produce divergent light beams to increase an optical spread of each of the plurality of pixel light beams. By doing so, a beam width of the plurality of pixel light beams is increased by the diffuser screen 210 in order to increase a size of an eyebox (e.g., a size of an area at which the projected image can be perceived by the user). The size of the eyebox may correspond to a degree of beam divergence (e.g., an angle of divergence) produced by the diffuser screen 210. In addition, the diffuser screen 210 may be configured to isolate and protect the HUD system 200 (e.g., the HUD reflector 202) from excessive sunlight by filtering out or blocking ambient light.

The HUD reflector 202 is configured to receive the plurality of divergent pixel light beams from the diffuser screen and reflect the plurality of divergent pixel light beams toward a field of view (e.g., toward the eyebox). The HUD reflector 202 has a first curved body 212 with a first surface curvature 214 that is configured to produce a reflector field curvature (e.g., field of curvature) in object space. The reflector field curvature is another virtual curvature and represents a virtual (e.g., imaginary) surface which, if used as an image source for projecting onto the HUD reflector 202, would give the best results for projecting the image to a defined distance or to infinity. Thus, the reflector field curvature may be referred to as field curvature of reflector projection. The reflector field curvature may also be referred to as a Petzval field curvature. The reflector field curvature of the HUD reflector 202 as is a curved virtual plane that has a virtual surface curvature.

The diffuser screen 210 includes a second curved body 216 with a second surface curvature 218. In is note that the diffuser screen 210 has an additional surface curvature that is arranged opposite to the second surface curvature 218. The additional surface curvature may be concentric with the second surface curvature 218. In some implementations, the second surface curvature 218 is matched or substantially matched with the reflector field curvature of the HUD reflector 202. In other words, the diffuser screen 210 is used as an image source for projecting the plurality of pixel light beams onto the HUD reflector 202. Thus, by matching the second surface curvature 218 of the diffuser screen 210 with the reflector field curvature of the HUD reflector 202, the diffuser screen 210 may be configured to give the best results for projecting the image from the HUD reflector 202 to a defined distance or to infinity. Accordingly, the diffuser screen 210 is not only configured to increase the beam width of the light beams projected at the HUD reflector 202, but a shape of the second curved body 216 of the diffuser screen 210 provides an optimized focus surface for the image projection by being matched with the reflector field curvature of the HUD reflector 202.

The second curved body 216 may include a first body edge, a second body edge, and a body center arranged between the first body edge and the second body edge. In some implementations, the degree of divergence of the second curved body 216 is at a maximum at the body center and at a minimum at the first body edge and the second body edge. In some implementations, the degree of divergence of the second curved body 216 may be constant throughout the second curved body 216. Accordingly, the beam width of a divergent pixel light beam of the plurality of divergent pixel light beams may be proportional to the degree of divergence of a region of the second curved body 216 at which the divergent pixel light beam is incident.

In some implementations, the projection field curvature of the 2D scanner 208 is matched or substantially matched with the reflector field curvature. In some implementations, the projection field curvature of the 2D scanner 208 overlaps with the reflector field curvature. In some implementations, the second curved body 216 of the diffuser screen 210 overlaps with the projection field curvature of the 2D scanner 208. For example, the

In some implementations, the term “matched” may refer to a same radial curvature where a radius of one curvature is equal to a radius of another curvature. In some implementations, the term “matched” may refer to congruent curvatures where two curvatures coincide exactly when superimposed or overlapped. In some implementations, the term “matched” may refer to concentric curvatures where one curvature is concentric with another curvature.

As indicated above, FIG. 2 is provided merely as an example. Other examples are possible and may differ from what was described with regard to FIG. 2. The number and arrangement of components shown in FIG. 2 are provided as an example. In practice, the HUD system 200 may include additional components, fewer components, different components, or differently arranged components than those shown in FIG. 2. Two or more components shown in FIG. 2 may be implemented within a single component, or a single component shown in FIG. 2 may be implemented as multiple, distributed components. Additionally, or alternatively, a set of components (e.g., one or more components) of the HUD system 200 may perform one or more functions described as being performed by another set of components of the HUD system 200.

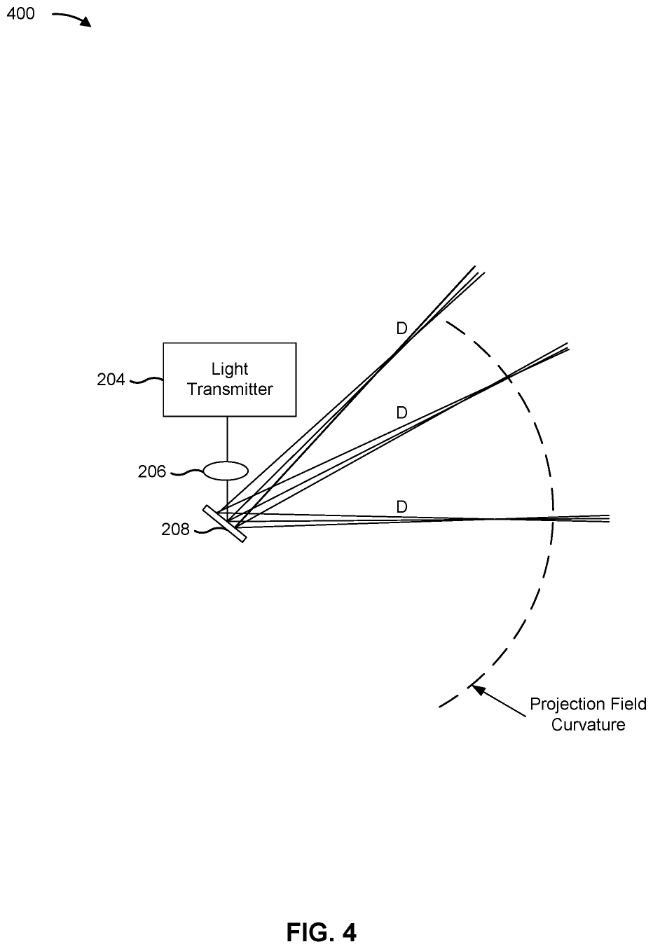

FIG. 3 illustrates an example HUD system 300 according to one or more implementations. The HUD system 300 is similar to the HUD system 200 described in connection with FIG. 2, but additionally includes a windshield 302 of a vehicle. In some implementations, the HUD system 300 includes a windshield reflector 304 that is mounted on or embedded in the windshield 302. The light transmitter 204, the pre-scan lens 206, and the 2D scanner 208 and provided as an image generation unit 306.

The HUD reflector 202 is configured to receive each of the plurality of pixel light beams from the diffuser screen 210 and project an image formed by the plurality of pixel light beams and a 2D scanning pattern implemented by the 2D scanner 208 onto the windshield 302 (e.g., onto the windshield reflector 304) by reflecting each of the plurality of pixel light beams onto the windshield 302. The HUD reflector 202 has a curved body (e.g., the first curved body 212), such as a convex shape or convex contour, that is designed to receive the plurality of pixel light beams and reflect the plurality of pixel light beams towards a display area of the windshield 302 (e.g., onto the windshield reflector 304). The windshield reflector 304 may be configured to reflect each of the plurality of pixel light beams towards a user, at which point the user perceives the projected image formed by the plurality of pixel light beams. Thus, FIG. 3 illustrates a full optical path (e.g., a full transmission path) of the plurality of pixel light beams.

The number and arrangement of components shown in FIG. 3 are provided as an example. In practice, the HUD system 300 may include additional components, fewer components, different components, or differently arranged components than those shown in FIG. 3A.

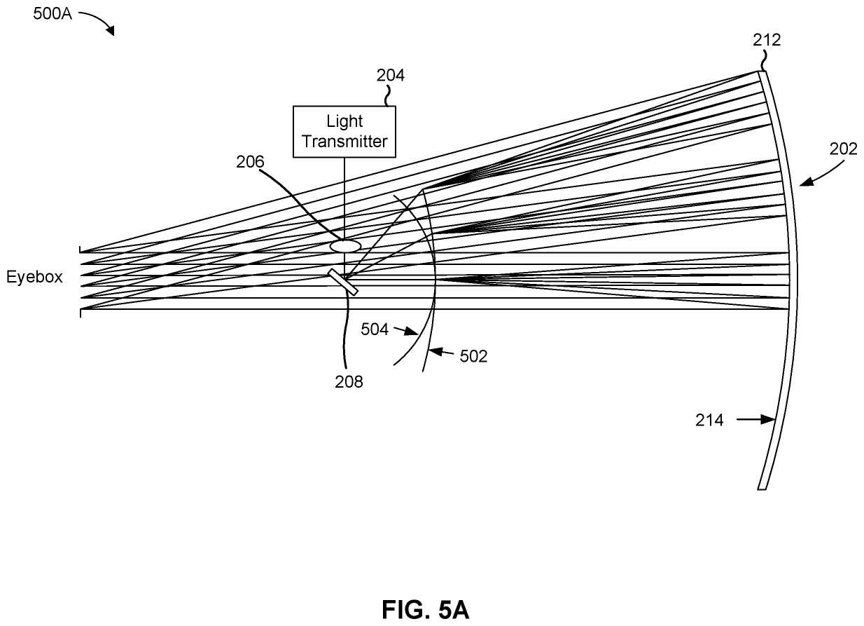

FIG. 4 illustrates an example image generation unit 400 according to one or more implementations. The image generation unit 400 may be similar to the image generation unit 306 described in connection with FIG. 3. Thus, the image generation unit 400 includes the light transmitter 204, the light transmitter 204, the pre-scan lens 206, and the 2D scanner 208. The image generation unit 400 may be implemented as part of a HUD system (e.g., the HUD system 200 or the HUD system 300).

FIG. 4 shows the projection field curvature of the 2D scanner 208 formed by a scanning motion on a scanning axis. The projection field curvature is a curved projection plane, formed by a scanning movement of the 2D scanner, at which light beams projected by the 2D scanner 208 are in focus. For example, the scanning motion of the 2D scanner 208 may produce the projection field curvature (e.g., a field curvature of LBS projection). The projection field curvature is representative of a virtual (e.g., imaginary) surface where projected light beams would be in-focus. Due to the scanning motion of the 2D scanner about a scanning axis (or two scanning axes), the projection field curvature is a curved projection plane that has a virtual surface curvature.

In some implementations, the second curved body 216 of the diffuser screen 210 may be curved to match the projection field curvature of the 2D scanner 208. In other words, the second surface curvature 218 of the diffuser screen 210 may be matched or substantially matched with the projection field curvature of the 2D scanner 208. The diffuser screen 210 may be positioned to overlap with or be superimposed on the projection field curvature of the 2D scanner 208 such that the second curved body 216 of the diffuser screen 210 fully overlaps with the projection field curvature of the 2D scanner 208, or vice versa. As a result, each pixel light beam of the plurality of pixel light beams that is incident on the diffuser screen 210 is in-focus on the diffuser screen 210.

For example, the pre-scan lens 206 may be configured to receive the plurality of pixel light beams from the light transmitter 204 and focus the plurality of pixel light beams onto the diffuser screen 210 based on the focal length of the pre-scan lens 206. The focal length of the pre-scan lens 206 may be equal to a sum of a first distance between the pre-scan lens 206 and the 2D scanner 208, along the optical path, and a second distance (e.g., a light projection distance D) between the 2D scanner 208 and the diffuser screen 210, along the optical path. Thus, the projection field curvature of the 2D scanner 208 may be determined by the focal length of the pre-scan lens 206 and properties of the 2D scanner 208.

In addition, when the second curved body 216 of the diffuser screen 210 fully overlaps with the projection field curvature of the 2D scanner 208, the light projection distance D from the 2D scanner 208 to the second curved body 216 of the diffuser screen 210 may remain substantially constant as a scanning position of the 2D scanner 208 changes according to the 2D scanning pattern. Furthermore, when the second curved body 216 of the diffuser screen 210 fully overlaps with the projection field curvature of the 2D scanner 208, the light projection distance D may be substantially equal to a radius of the second surface curvature 218 of the diffuser screen 210.

In addition, in some implementations, the projection field curvature of the 2D scanner 208 may overlap (e.g., fully overlap) with the reflector field curvature of the HUD reflector 202, or vice versa. In some implementations, the second curved body 216 of the diffuser screen 210 may overlap (e.g., fully overlap) with the projection field curvature of the 2D scanner 208 and the reflector field curvature of the HUD reflector 202.

As a result, an image that is projected by the HUD system may remain in focus at the user throughout an entire scanning operation of the 2D scanner 208. In other words, the image may be enhanced by the HUD system.

The number and arrangement of components shown in FIG. 4 are provided as an example. In practice, the image generation unit 400 may include additional components, fewer components, different components, or differently arranged components than those shown in FIG. 4.

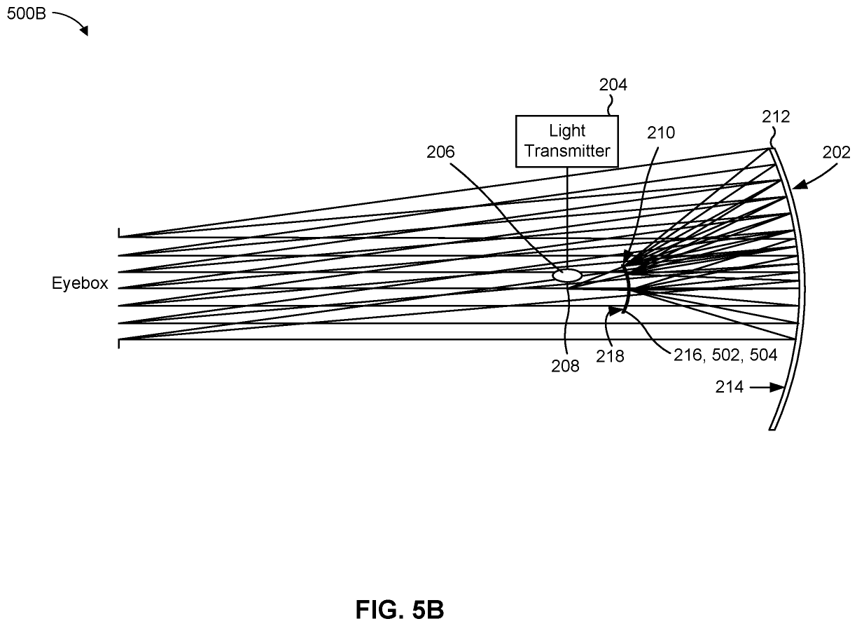

FIG. 5A illustrates an example HUD system 500A according to one or more implementations. The HUD system 500A may be similar to the HUD system 200 described in connection with FIG. 2. In this example, the HUD reflector 202 includes the first curved body 212 with the first surface curvature 214 that is configured to produce a reflector field curvature 502 in object space. In addition, the projection field curvature of the 2D scanner 208 is shown as projection field curvature 504. In this example, the projection field curvature 504 partially overlaps with the reflector field curvature 502. However, the projection field curvature 504 partially is not matched with the reflector field curvature 502. For example, a radius of the projection field curvature 504 is different from a radius of the reflector field curvature 502. In this case, the radius of the projection field curvature 504 and the radius of the reflector field curvature 502 are significantly different from each other. As a result, the image received at the eyebox may be in-focus some of the time (e.g., for part of the scanning operation of the 2D scanner) where the projection field curvature 504 and the radius of the reflector field curvature 502 overlap and would likely be out-of-focus for part of the scanning operation of the 2D scanner where the projection field curvature 504 and the radius of the reflector field curvature 502 do not overlap.

The number and arrangement of components shown in FIG. 5A are provided as an example. In practice, the HUD system 500A may include additional components, fewer components, different components, or differently arranged components than those shown in FIG. 5A.

FIG. 5B illustrates an example HUD system 500B according to one or more implementations. The HUD system 500B may be similar to the HUD system 200 described in connection with FIG. 2. Additionally, the HUD system 500B may include the image generation unit 400 described in connection with FIG. 4. Additionally, the HUD system 500B may be similar to the HUD system 500A described in connection with FIG. 5A, with the exception that the reflector field curvature 502 and the projection field curvature 504 are matched to each other. For example, the radius of the reflector field curvature 502 is equal to or substantially equal to the radius of the projection field curvature 504. As a result, the projection field curvature 504 may fully overlap with or be fully superimposed on the reflector field curvature 502.

Furthermore, the diffuser screen 210 may be positioned to overlap (e.g., fully overlap) with the reflector field curvature 502 and the projection field curvature 504. In particular, the diffuser screen 210 includes the second curved body 216 with the second surface curvature 218. The second surface curvature 218 may be matched or substantially matched with the reflector field curvature 502 of the HUD reflector 202. Thus, a physical curvature of the diffuser screen 210 may match (e.g., is substantially equal to) the reflector field curvature 502 (e.g., the Petzval field curvature) of the HUD reflector 202. In other words, a radius of the second curved body 216 (e.g., a radius of the second surface curvature 218) may be equal to or substantially equal to the radius of the reflector field curvature 502. Moreover, since the radius of the reflector field curvature 502 is matched with the radius of the projection field curvature 504, the radius of the second curved body 216 (e.g., the radius of the second surface curvature 218) may be equal to or substantially equal to the radius of the projection field curvature 504.

In addition, a light projection distance from the 2D scanner 208 to the first curved body 212 of the HUD reflector 202 may remain substantially constant as a scanning position of the 2D scanner 208 changes according to the 2D scanning pattern. In some implementations, the light projection distance from the 2D scanner 208 to the first curved body 212 of the HUD reflector 202 may be equal to or substantially equal to a radius of the first surface curvature 214.

In some implementations, a first light projection distance from the 2D scanner 208 to the first curved body 212 remains substantially constant as a scanning position of the 2D scanner 208 changes according to the 2D scanning pattern, and a second light projection distance from the 2D scanner 208 to the second curved body 216 remains substantially constant as the scanning position of the 2D scanner 208 changes according to the 2D scanning pattern. Moreover, the second light projection distance may be substantially equal to the radius of the second surface curvature 218.

In some implementations, the focal length of the pre-scan lens 206 may be equal to or substantially equal to half of a radius of the first surface curvature 214.

By matching the second surface curvature 218 of the diffuser screen 210 with the reflector field curvature of the HUD reflector 202, the diffuser screen 210 may be configured to give the best results for projecting the image from the HUD reflector 202 to a defined distance or to infinity. Accordingly, the diffuser screen 210 is not only configured to increase the beam width of the light beams projected at the HUD reflector 202, but a shape of the second curved body 216 of the diffuser screen 210 provides an optimized focus surface for the image projection by being matched with the reflector field curvature of the HUD reflector 202. Moreover, by superimposing the diffuser screen 210 onto the projection field curvature 504, as shown in FIG. 5B, the pixel light beams are received by the diffuser screen 210, in-focus, throughout the entire scanning operation and the pixel light beams are projected from the reflector field curvature 502, by the diffuser screen 210, onto the HUD reflector 202.

Accordingly, optical aberrations caused, for example, by a compact HUD architecture, can be reduced or prevented altogether and a quality of the projected image can be increased while achieving larger eyebox sizes. For example, matching the reflector field curvature 502 and the projection field curvature 504 may improve image resolution, may reduce system size, and/or may reduce system complexity.

Additionally, a Petzval radius of the HUD reflector 202 may be compensated by a shape of the diffuser screen 210, which may allow for the HUD reflector 202 to have a shorter focal length. As a result of the HUD reflector 202 having a shorter focal length, the HUD system 500B as a whole may have a more compact design.

Additionally, due to the reflector field curvature 502 and the projection field curvature 504 being matched to each other (e.g., equal radii), there may be no loss in beam quality from the diffuser screen 210 to the user (e.g., to the eyebox).

Additionally, a diffusion behavior of the diffuser screen 210 may have a maximum scattering direction perpendicular to the diffuser screen 210, saving costs.

Additionally, no additional optics may be needed. Thus, a simple pre-scan focusing method can be used, saving costs.

The number and arrangement of components shown in FIG. 5B are provided as an example. In practice, the HUD system 500B may include additional components, fewer components, different components, or differently arranged components than those shown in FIG. 5B.

The following provides an overview of some Aspects of the present disclosure:

Aspect 1: A head-up display (HUD) system, comprising: a HUD reflector comprising a first curved body with a first surface curvature that is configured to produce a reflector field curvature in object space; a light transmitter configured to generate a plurality of pixel light beams corresponding to an image and transmit the plurality of pixel light beams on an optical path toward the HUD reflector; a two-dimensional (2D) scanner arranged on the optical path, wherein the 2D scanner is configured to receive the plurality of pixel light beams from the light transmitter and steer the plurality of pixel light beams along the optical path according to a 2D scanning pattern; and a diffuser screen arranged on the optical path between the 2D scanner and the HUD reflector, wherein the diffuser screen comprises a second curved body with a second surface curvature that is substantially matched with the reflector field curvature, wherein the diffuser screen is configured to receive the plurality of pixel light beams from the 2D scanner and expand a beam width of each pixel light beam of the plurality of pixel light beams to generate a plurality of divergent pixel light beams, and wherein the HUD reflector is configured to receive the plurality of divergent pixel light beams from the diffuser screen and reflect the plurality of divergent pixel light beams toward a field of view.

Aspect 2: The HUD system of Aspect 1, wherein the reflector field curvature is a Petzval field curvature.

Aspect 3: The HUD system of any of Aspects 1-2, wherein the 2D scanner is configured to scan the plurality of pixel light beams onto the diffuser screen according to the 2D scanning pattern.

Aspect 4: The HUD system of any of Aspects 1-3, wherein the 2D scanner has a projection field curvature that is substantially matched with the reflector field curvature.

Aspect 5: The HUD system of Aspect 4, wherein the projection field curvature is a curved projection plane, formed by a scanning movement of the 2D scanner, at which the plurality of pixel light beams are in focus.

Aspect 6: The HUD system of Aspect 4, wherein the projection field curvature overlaps with the reflector field curvature.

Aspect 7: The HUD system of Aspect 6, wherein the second curved body of the diffuser screen overlaps with the projection field curvature.

Aspect 8: The HUD system of Aspect 4, wherein the 2D scanner includes a microelectromechanical system (MEMS) mirror configured to oscillate about a first axis according to a first oscillation and oscillate about a second axis according to a second oscillation, wherein the first oscillation and the second oscillation form the 2D scanning pattern, and wherein the projection field curvature is a projection field curvature of the MEMS mirror that is substantially matched with the reflector field curvature.

Aspect 9: The HUD system of any of Aspects 1-8, wherein a light projection distance from the 2D scanner to the second curved body remains substantially constant as a scanning position of the 2D scanner changes according to the 2D scanning pattern.

Aspect 10: The HUD system of Aspect 9, wherein the light projection distance is substantially equal to a radius of the second surface curvature.

Aspect 11: The HUD system of any of Aspects 1-10, wherein a light projection distance from the 2D scanner to the first curved body remains substantially constant as a scanning position of the 2D scanner changes according to the 2D scanning pattern.

Aspect 12: The HUD system of Aspect 11, wherein the light projection distance is substantially equal to a radius of the first surface curvature.

Aspect 13: The HUD system of any of Aspects 1-12, wherein a first light projection distance from the 2D scanner to the first curved body remains substantially constant as a scanning position of the 2D scanner changes according to the 2D scanning pattern, wherein a second light projection distance from the 2D scanner to the second curved body remains substantially constant as the scanning position of the 2D scanner changes according to the 2D scanning pattern, and wherein the second light projection distance is substantially equal to a radius of the second surface curvature,

Aspect 14: The HUD system of any of Aspects 1-13, further comprising: a pre-scan lens arranged on the optical path between the light transmitter and the 2D scanner, wherein the pre-scan lens is configured to receive the plurality of pixel light beams from the light transmitter and focus the plurality of pixel light beams onto the diffuser screen.

Aspect 15: The HUD system of Aspect 14, wherein a focal length of the pre-scan lens is equal to a sum of a first distance between the pre-scan lens and the 2D scanner, along the optical path, and a second distance between the 2D scanner and the diffuser screen, along the optical path.

Aspect 16: The HUD system of Aspect 14, wherein a focal length of the pre-scan lens is substantially equal to half of a radius of the first surface curvature.

Aspect 17: The HUD system of any of Aspects 1-16, further comprising: a windshield comprising a windshield reflector configured to receive the plurality of divergent pixel light beams from the HUD reflector and project the image into the field of view.

Aspect 18: A head-up display (HUD) system, comprising: a light transmitter configured to generate a plurality of pixel light beams corresponding to an image and transmit the plurality of pixel light beams on an optical path; a two-dimensional (2D) scanner arranged on the optical path, wherein the 2D scanner is configured to receive the plurality of pixel light beams from the light transmitter and steer the plurality of pixel light beams along the optical path according to a 2D scanning pattern; and a diffuser screen arranged on the optical path downstream from the 2D scanner, wherein the diffuser screen comprises a curved body with a surface curvature, and wherein the diffuser screen is configured to receive the plurality of pixel light beams from the 2D scanner and expand a beam width of each pixel light beam of the plurality of pixel light beams to generate a plurality of divergent pixel light beams, and wherein the 2D scanner has a projection field curvature that is substantially matched with the surface curvature of the diffuser screen.

Aspect 19: The HUD system of Aspect 18, wherein a light projection distance from the 2D scanner to the curved body remains substantially constant as a scanning position of the 2D scanner changes according to the 2D scanning pattern, and wherein the light projection distance is substantially equal to a radius of the surface curvature.

Aspect 20: The HUD system of any of Aspects 18-19, wherein the curved body of the diffuser screen overlaps with the projection field curvature.

Aspect 21: The HUD system of any of Aspects 18-20, further comprising: a pre-scan lens arranged on the optical path between the light transmitter and the 2D scanner, wherein the pre-scan lens is configured to receive the plurality of pixel light beams from the light transmitter and focus the plurality of pixel light beams onto the diffuser screen, wherein a focal length of the pre-scan lens is equal to a sum of a first distance between the pre-scan lens and the 2D scanner, along the optical path, and a second distance between the 2D scanner and the diffuser screen, along the optical path.

Aspect 22: A head-up display (HUD) system, comprising: a light transmitter configured to generate a plurality of pixel light beams corresponding to an image and transmit the plurality of pixel light beams on an optical path; a two-dimensional (2D) scanner arranged on the optical path, wherein the 2D scanner is configured to receive the plurality of pixel light beams from the light transmitter and steer the plurality of pixel light beams along the optical path according to a 2D scanning pattern; a diffuser screen arranged on the optical path downstream from the 2D scanner, wherein the diffuser screen comprises a curved body having a surface curvature, and wherein the diffuser screen is configured to receive the plurality of pixel light beams from the 2D scanner and expand a beam width of each pixel light beam of the plurality of pixel light beams to generate a plurality of divergent pixel light beams; and a pre-scan lens arranged on the optical path between the light transmitter and the 2D scanner, wherein the pre-scan lens is configured to receive the plurality of pixel light beams from the light transmitter and focus the plurality of pixel light beams onto the diffuser screen, wherein a focal length of the pre-scan lens is equal to a sum of a first distance between the pre-scan lens and the 2D scanner, along the optical path, and a second distance between the 2D scanner and the diffuser screen, along the optical path, and wherein the second distance is substantially equal to a radius of the surface curvature.

Aspect 23: A system configured to perform one or more operations recited in one or more of Aspects 1-22.

Aspect 24: An apparatus comprising means for performing one or more operations recited in one or more of Aspects 1-22.

Aspect 25: A non-transitory computer-readable medium storing a set of instructions, the set of instructions comprising one or more instructions that, when executed by a device, cause the device to perform one or more operations recited in one or more of Aspects 1-22.

Aspect 26: A computer program product comprising instructions or code for executing one or more operations recited in one or more of Aspects 1-22.

The foregoing disclosure provides illustration and description, but is not intended to be exhaustive or to limit the implementations to the precise form disclosed. Modifications and variations are possible in light of the above disclosure or may be acquired from practice of the implementations.

For example, although implementations described herein relate to MEMS devices with a mirror, it is to be understood that other implementations may include optical devices other than MEMS mirror devices or other MEMS oscillating structures. In addition, although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer, or an electronic circuit.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware can be designed to implement the systems and/or methods based on the description herein.

Further, it is to be understood that the disclosure of multiple acts or functions disclosed in the specification or in the claims may not be construed as to be within the specific order. Therefore, the disclosure of multiple acts or functions will not limit these to a particular order unless such acts or functions are not interchangeable for technical reasons. Furthermore, in some implementations a single act may include or may be broken into multiple sub acts. Such sub acts may be included and part of the disclosure of this single act unless explicitly excluded.

Instructions may be executed by one or more processors, such as one or more central processing units (CPU), digital signal processors (DSPs), general purpose microprocessors, application specific integrated circuits (ASICs), field programmable logic arrays (FPLAs), or other equivalent integrated or discrete logic circuitry. Accordingly, the term “processor” or “processing circuitry” as used herein refers to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

Thus, the techniques described in this disclosure may be implemented, at least in part, in hardware, software executing on hardware, firmware, or any combination thereof. For example, various aspects of the described techniques may be implemented within one or more processors, including one or more microprocessors, DSPs, ASICs, or any other equivalent integrated or discrete logic circuitry, as well as any combinations of such components.

A controller including hardware may also perform one or more of the techniques described in this disclosure. Such hardware, software, and firmware may be implemented within the same device or within separate devices to support the various techniques described in this disclosure. Software may be stored on a non-transitory computer-readable medium such that the non-transitory computer readable medium includes a program code or a program algorithm stored thereon which, when executed, causes the controller, via a computer program, to perform the steps of a method.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A head-up display (HUD) system, comprising:
a HUD reflector comprising a first curved body with a first surface curvature that is configured to produce a reflector field curvature in object space;
a light transmitter configured to generate a plurality of pixel light beams corresponding to an image and transmit the plurality of pixel light beams on an optical path toward the HUD reflector;
a two-dimensional (2D) scanner arranged on the optical path, wherein the 2D scanner is configured to receive the plurality of pixel light beams from the light transmitter and steer the plurality of pixel light beams along the optical path according to a 2D scanning pattern; and
a diffuser screen arranged on the optical path between the 2D scanner and the HUD reflector, wherein the diffuser screen comprises a second curved body with a second surface curvature that is substantially matched with the reflector field curvature,
wherein the diffuser screen is configured to receive the plurality of pixel light beams from the 2D scanner and expand a beam width of each pixel light beam of the plurality of pixel light beams to generate a plurality of divergent pixel light beams, and
wherein the HUD reflector is configured to receive the plurality of divergent pixel light beams from the diffuser screen and reflect the plurality of divergent pixel light beams toward a field of view.

2. The HUD system of claim 1, wherein the reflector field curvature is a Petzval field curvature.

3. The HUD system of claim 1, wherein the 2D scanner is configured to scan the plurality of pixel light beams onto the diffuser screen according to the 2D scanning pattern.

4. The HUD system of claim 1, wherein the 2D scanner has a projection field curvature that is substantially matched with the reflector field curvature.

5. The HUD system of claim 4, wherein the projection field curvature is a curved projection plane, formed by a scanning movement of the 2D scanner, at which the plurality of pixel light beams are in focus.

6. The HUD system of claim 4, wherein the projection field curvature overlaps with the reflector field curvature.

7. The HUD system of claim 6, wherein the second curved body of the diffuser screen overlaps with the projection field curvature.

8. The HUD system of claim 4, wherein the 2D scanner includes a microelectromechanical system (MEMS) mirror configured to oscillate about a first axis according to a first oscillation and oscillate about a second axis according to a second oscillation, wherein the first oscillation and the second oscillation form the 2D scanning pattern, and
wherein the projection field curvature is a projection field curvature of the MEMS mirror that is substantially matched with the reflector field curvature.

9. The HUD system of claim 1, wherein a light projection distance from the 2D scanner to the second curved body remains substantially constant as a scanning position of the 2D scanner changes according to the 2D scanning pattern.

10. The HUD system of claim 9, wherein the light projection distance is substantially equal to a radius of the second surface curvature.

11. The HUD system of claim 1, wherein a light projection distance from the 2D scanner to the first curved body remains substantially constant as a scanning position of the 2D scanner changes according to the 2D scanning pattern.

12. The HUD system of claim 11, wherein the light projection distance is substantially equal to a radius of the first surface curvature.

13. The HUD system of claim 1, wherein a first light projection distance from the 2D scanner to the first curved body remains substantially constant as a scanning position of the 2D scanner changes according to the 2D scanning pattern,
wherein a second light projection distance from the 2D scanner to the second curved body remains substantially constant as the scanning position of the 2D scanner changes according to the 2D scanning pattern, and
wherein the second light projection distance is substantially equal to a radius of the second surface curvature.

14. The HUD system of claim 1, further comprising:
a pre-scan lens arranged on the optical path between the light transmitter and the 2D scanner, wherein the pre-scan lens is configured to receive the plurality of pixel light beams from the light transmitter and focus the plurality of pixel light beams onto the diffuser screen.

15. The HUD system of claim 14, wherein a focal length of the pre-scan lens is equal to a sum of a first distance between the pre-scan lens and the 2D scanner, along the optical path, and a second distance between the 2D scanner and the diffuser screen, along the optical path.

16. The HUD system of claim 14, wherein a focal length of the pre-scan lens is substantially equal to half of a radius of the first surface curvature.

17. The HUD system of claim 1, further comprising:
a windshield comprising a windshield reflector configured to receive the plurality of divergent pixel light beams from the HUD reflector and project the image into the field of view.

18. A head-up display (HUD) system, comprising:
a light transmitter configured to generate a plurality of pixel light beams corresponding to an image and transmit the plurality of pixel light beams on an optical path;
a two-dimensional (2D) scanner arranged on the optical path, wherein the 2D scanner is configured to receive the plurality of pixel light beams from the light transmitter and steer the plurality of pixel light beams along the optical path according to a 2D scanning pattern; and
a diffuser screen arranged on the optical path downstream from the 2D scanner, wherein the diffuser screen comprises a curved body with a surface curvature, and wherein the diffuser screen is configured to receive the plurality of pixel light beams from the 2D scanner and expand a beam width of each pixel light beam of the plurality of pixel light beams to generate a plurality of divergent pixel light beams, and
wherein the 2D scanner has a projection field curvature that is substantially matched with the surface curvature of the diffuser screen.

19. The HUD system of claim 18, wherein a light projection distance from the 2D scanner to the curved body remains substantially constant as a scanning position of the 2D scanner changes according to the 2D scanning pattern, and
wherein the light projection distance is substantially equal to a radius of the surface curvature.

20. The HUD system of claim 18, wherein the curved body of the diffuser screen overlaps with the projection field curvature.

21. The HUD system of claim 18, further comprising:
a pre-scan lens arranged on the optical path between the light transmitter and the 2D scanner, wherein the pre-scan lens is configured to receive the plurality of pixel light beams from the light transmitter and focus the plurality of pixel light beams onto the diffuser screen,
wherein a focal length of the pre-scan lens is equal to a sum of a first distance between the pre-scan lens and the 2D scanner, along the optical path, and a second distance between the 2D scanner and the diffuser screen, along the optical path.

22. A head-up display (HUD) system, comprising:
a light transmitter configured to generate a plurality of pixel light beams corresponding to an image and transmit the plurality of pixel light beams on an optical path;
a two-dimensional (2D) scanner arranged on the optical path, wherein the 2D scanner is configured to receive the plurality of pixel light beams from the light transmitter and steer the plurality of pixel light beams along the optical path according to a 2D scanning pattern;
a diffuser screen arranged on the optical path downstream from the 2D scanner, wherein the diffuser screen comprises a curved body having a surface curvature, and wherein the diffuser screen is configured to receive the plurality of pixel light beams from the 2D scanner and expand a beam width of each pixel light beam of the plurality of pixel light beams to generate a plurality of divergent pixel light beams; and
a pre-scan lens arranged on the optical path between the light transmitter and the 2D scanner, wherein the pre-scan lens is configured to receive the plurality of pixel light beams from the light transmitter and focus the plurality of pixel light beams onto the diffuser screen,
wherein a focal length of the pre-scan lens is equal to a sum of a first distance between the pre-scan lens and the 2D scanner, along the optical path, and a second distance between the 2D scanner and the diffuser screen, along the optical path, and
wherein the second distance is substantially equal to a radius of the surface curvature.
